(19) United States
(12) Patent Application Publication
(10) Pub. No.: US 2007/0286546 A1
(43) Pub. Date: Dec. 13, 2007

(54) Surface Initiated Thin Polymeric Films for Chemical Sensors

(76) Inventors: Jean-Francois Masson, Decatur, GA (US); Karl S. Booksh, Hockessin, DE (US); Anna Prakash, Mesa, AZ (US); Yoon Chang Kim, Newark, DE (US)

Correspondence Address: David S Harper;McDonnell Boehnen Hulbert & Berghoff, Suite 3100, 300 South Wacker Drive, Chicago, IL, 60606, US

(21) Appl. No.: 10/548,621

(22) PCT Filed: Mar. 11, 2004
(86) PCT No.: PCT/US04/07586

§ 371 Date: Apr. 4, 2007

Related U.S. Application Data
(60) Provisional application No. 60/454,173, filed on Mar. 11, 2003.

(51) Int. Cl. G02B 6/00

(52) U.S. Cl. 385/12; 438/49

(57) ABSTRACT

Surface active sensors comprising imprinted functional polymer matrices tailor made to detect specific chemical species of interest, and a label free, surface initiated molecular imprinting technology for applications in surface active sensors are provided.

### FIELD OF THE INVENTION

The current invention is directed generally to surface active sensors; and more particularly to surface active sensors comprising molecularly imprinted sensing elements for the detection of molecules and ions, and the methods of manufacturing such elements.

### BACKGROUND OF THE INVENTION

An urgent need exists for molecular sensors that can operate in hostile chemical environments, in real time, and which can provide fast, accurate signals, for example, for confirming the presence or the absence of a toxic chemical or for biochemical medical diagnosis techniques. Although a number of analytical methods have been developed for the detection of molecular species, such as toxic chemicals, including ion mobility spectrometry (IMS), high performance liquid chromatographs-gas chromatographs/mass spectrometers (HPLC-GC/MS), luminescence spectroscopy, enzyme-based chemistry and others. However, these techniques all have serious limitations. For example, ‘matrix effects’ such as humidity, temperature, and the composition of the air sample can easily influence IMS detector response. HPLC-GC/MS requires extensive pre-analysis procedures. The enzyme chemistry used in field analysis today can take up to 20-30 minutes to respond and are not reusable. Luminescence based fiber optic sensors can take about 15 minutes to respond & have optical components that are not field portable.

Recently interest has turned to surface active sensors such as, fiber optic based surface acoustic wave (SAW), and surface plasmon resonance (SPR) toxic chemical and biochemical sensors. Surface active sensors are based on an electron charge density wave phenomenon that arises at the surface of a metallic film when light is reflected at the film under specific conditions. Because of its high sensitivity, this technique is used to measure the optical properties of chemical reactions as they occur in real time. These sensors, such as SAW and SPR-based sensors represent a promising alternative as they are better suited for rapid data collection without sample pretreatment and can access remote locations and provide fast, accurate signals in an emergency. However, current methods of manufacturing these devices severely limits the applicability of these sensors.

For example, currently available molecularly imprinted polymers (MIP) based chemical and biochemical sensors are produced by dip coating of a preformed polymer, or by selective adsorption of a diblock copolymer directly on to the sensing surface. However, stearic and entropic forces hamper the growth of nano-scale layers from solution once the surface is significantly covered with an initial layer of a polymer layer. In addition, it is almost impossible to remove all of the template molecules from the thick polymer layers resulting in poor performance due to template leaching over time, and controlling the thickness of the molecularly imprinted polymers is critical to the performance of these types of sensors.

Additionally, in surface plasma resonance based detection methods, the effective distance of surface plasmon penetration is only few hundred nanometers. Therefore, molecularly imprinted nanolayers of polymers are critical to the sensitivity, selectivity and reproducibility of SPR based sensors. Meanwhile, SAW based sensors, although fast, respond to all organophosphates and are sometimes irreversible.

Accordingly, a need exists for new surface active sensor probes and methods of controllably manufacturing surface active sensor probes and detectors.

### SUMMARY OF THE INVENTION

The present invention is directed to sensing elements in surface active based sensors that are mechanically and chemically stable enough to liberate or absorb the imprinting species in harsh chemical environments.

In one embodiment the sensing elements according to the current invention comprise molecularly imprinted surface grown polymers or cavity containing nano-layers. In such an embodiment, selectivity for a specific molecule or ion may be obtained by providing cavities lined with complexing ligands so arranged as to match the charge, coordination number, coordination geometry and/or size of the specific molecule or ion.

In another embodiment in accordance with the present invention, the selectivity and sensitivity of the sensor towards a specific molecule or ion may be tailored by controlling the chain length, polymer thickness, the type of the surface initiated polymer matrix and/or other related factors.

In still another embodiment in accordance with the present invention, the surface active sensors based may be designed to detect molecules of interest such as chemicals, biochemicals or ions in real time without sample pretreatment and withstand hostile chemical environments such as a range of pH and/or temperature conditions.

In yet another embodiment in accordance with the present invention, these sensing elements may be tailor made to detect any toxic chemical molecules or ions of interest in both gaseous and liquid phases.

In still yet another embodiment the present invention is directed to methods of manufacturing & optimizing surface plasmon resonance sensors that can detect the onset of myocardial ischemia and myocardial infarction (MI).

In still yet another embodiment the surface active sensors of the current invention are based on APR or SAW technologies.

In still yet another embodiment the present invention is directed to methods of manufacturing surface active sensors sensors. In one such embodiment surface initiated polymerization (SIP) techniques may be used for molecular imprinting on the surface active sensor probes. In such an embodiment a polymerization initiator is covalently linked to the sensing surface of the fiber, and then the polymerization of the target molecule is initiated on the surface of the sensor.

In still yet another embodiment in accordance with the present invention, the process involves building a complex of an imprint molecule and associated polymerizable ligands. The ligands in the complex are then copolymerized with surface initiated polymers such as Styrene to immobilize the complex. In such an embodiment, the movement of the molecules in and out of the imprinted polymer matrix creates a change in the refractive index of the layer, which is transduced by the evanescent field created by the surface plasma resonance.

### BRIEF DESCRIPTION OF THE DRAWINGS

These and other features and advantages of the present invention will become appreciated as the same becomes better understood with reference to the specification, claims and drawings wherein:

FIGS. 1a to 1c show schematics of a surface active sensor with surface initiated molecularly imprinted polymer in accordance with exemplary embodiments of the current invention.

FIG. 2a shows a schematic diagram of the surface plasmon resonance process.

FIG. 2b shows an exemplary reflection spectra freom an SPR-based surface active sensor.

FIG. 3 shows a molecular formula for a surface initiated polymer for a molecular imprinting in accordance with one exemplary embodiment of the current invention.

FIG. 4 shows a schematic diagram of an exemplary process for making an SPR sensor in accordance with an embodiment of the current invention.

FIG. 5 shows an SEM of the surface initiated polymerization of Styrene on a gold-coated glass surface

FIG. 6 shows a molecular diagram of a molecularly imprinted polymer for a sensor in accordance with one exemplary embodiment of the current invention.

FIG. 7 shows the SPR responses of an exemplary PMP sensor in accordance with one exemplary embodiment of the current invention in direct assay: where the solid line shows the results from the MIP-SPR probe; and the dotted line shows the results from the control-SPR probe.

FIG. 8a shows the graphical results of ammonium ion detection in an exemplary surface initiated polymer Styrene/Nonactin based system in accordance with the current invention.

FIG. 8b shows the graphical results of ammonium ion detection in an exemplary surface initiated polymer Styrene/Nonactin based system in accordance with the current invention.

FIG. 9 shows the graphical results of a resonance curve for one exemplary embodiment of an SPR sensor in accordance with the current invention.

FIG. 10 shows graphical results of experiments taken with an exemplary SPR sensor in accordance with the current invention.

FIG. 11 shows graphical results of experiments taken with an exemplary SPR sensor in accordance with the current invention.

FIGS. 12a and 12b show graphical results of experiments taken with an exemplary SPR sensor in accordance with the current invention.

FIGS. 13a and 13b show graphical results of experiments taken with an exemplary SPR sensor in accordance with the current invention.

FIGS. 14a and 14b show graphical results of experiments taken with an exemplary SPR sensor in accordance with the current invention.

### DETAILED DESCRIPTION OF THE INVENTION

The current invention is directed to surface active sensors comprising imprinted functional polymer matrices, which can be tailor made to detect specific molecular species of interest, and to a label free, surface initiated molecular imprinting technology for applications in surface active-based molecular sensors.

While SPR sensors are discussed herein as the primary example, the surface initiated polymerization reactions could be applied as a surface modification to any chemical sensor platform that relies on surface active detection. For example, SPR relies on surface refractive index changes following binding events. Loading of the polymer could result in surface mass changes detectable with quartz crystal microbalances, other piezoelectric oscillators or micro cantilevers. Deformability and rigidity of the polymer following binding would be detectable with surface acoustic wave sensors. Similarly, electrochemical or electric field changes could be detectable with a surface initiated conductive polymer or a surface initiated polymer grown on a field effect transistor.

The major challenge to the use of conventional surface active sensors in complex solutions is to reduce or eliminate sensor fouling. Because surface active sensors measure any change of refractive index at the probe surface, non-specific binding produces undistinguishable signal from specific binding. The surface initiated molecularly imprinted sensing elements of the current invention are tailor-made recognition elements (synthetic antibodies) that are capable of changing their optical characteristics in a predictable way in the presence of an imprint molecule and are less prone to suffer from changes in pH, temperature, and trace of impurities that can easily contaminate the sensing surface of conventional sensing elements for surface active sensors. Accordingly, the present invention is directed to surface active molecular sensors, and to their manufacture by growing nano-layers of molecularly imprinted polymers using surface initiated polymerization techniques for imprinting. It has been found that these sensors can be tailor made to sense a broad spectrum of toxic chemicals in real time, and in a variety of harsh chemical environments.

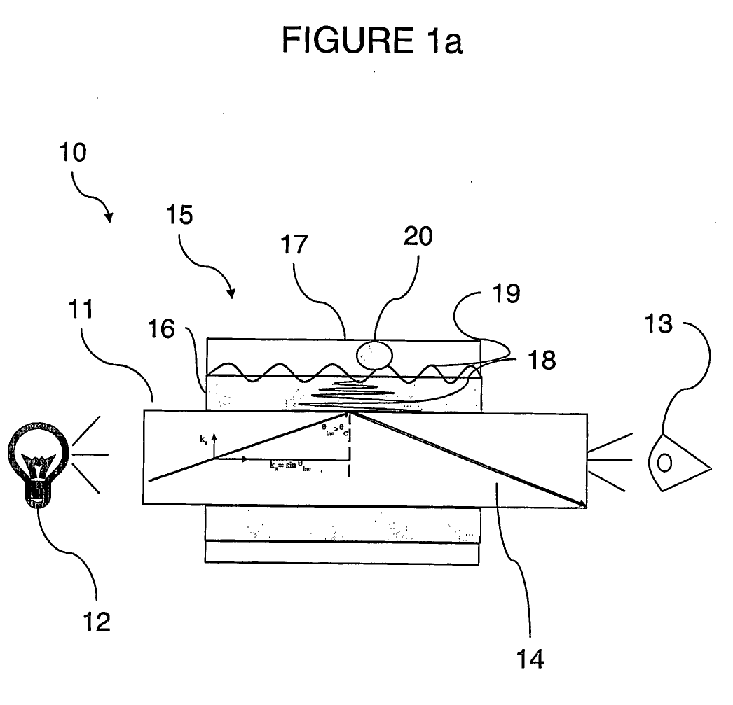

One generic embodiment of the surface active sensor of the current invention is shown schematically in FIG. 1a. As shown the sensor (10) generally comprises a waveguide (11) disposed between a wave source (12) and a wave detector (13). The nature of the waveguide, wave source and detector depends solely on the type of signal (14) being generated. In one embodiment the signal (14) is light, the waveguide (11) is a fiber-optic cable, the wave source (12) is a light source, and the detector (13) is a light sensitive element such as a photomultiplier tube. In such an embodiment, the sensor element (15) itself would be disposed on the waveguide (11) between the source (12) and the detector (13) such that the signal (14) would interact with the sensor element before being measured by the detector.

As shown in FIG. 1a, the sensor (15) itself generally comprises a conducting layer (16) in signal communication with the waveguide (11), and a molecularly imprinted polymer sensing layer (17) disposed atop the conductive layer in evanescent communication (18) with the waveguide such that the signal (14) from the source (12) interacts with the conductive layer (16) through some form of indirect wave interaction (19), such as, for example, surface acoustic waves or surface plasmon resonance through evanescent (18) coupling in the molecularly imprinted polymer sensing layer (17) such that a change in the refractive index of the sensing layer, such as, for example, through binding of a target molecule (20) would result in a perturbation in the signal being carried along the waveguide. The perturbation would then be measured by the detector (13) and the presence of the molecule could be appropriately indicated to a user.

A fiber-optic based surface plasma resonance sensor (10) in accordance with one embodiment of the current invention is shown in FIG. 1b. As is shown the sensor generally comprises a probe (21) itself including an optical fiber (22) having a tip (23) which is polished flat with lapping films. A mirror (24) is affixed onto the tip (23) of the fiber optic probe (21) by sputtering. The fiber (22) is then mounted in an optical connector (25) polished to ensure good optical coupling, such as, for example, an SMA type connector, with the fiber optic jumper. Finally, a sensing area (26) is formed adjacent to the tip of the fiber. A conductive layer (27), such as, for example a layer of gold or any other metal with free d-band electrons, is formed on the sensing area such that it is evanescently (28) coupled to the signal in the fiber (22). Nano-layers of molecularly imprinted polymers (29) are disposed on the sensing area (26) atop the conductive layer to allow for the imprinting of the sensor (10) for a specific target substance.

It should be understood that although an example of light-based fiberoptic SPR detector is described above, it should be understood that any suitable signal and waveguide combination capable of obtaining a signal from a surface sensor element of the type described herein may be utilized, such as, for example, a SAW device, piezoelectric or quartz crystal microbalance, micro cantilever, or field effect transistor. Likewise, although the probe design in this embodiment is a fiber-optic based device, the probe design may be any technology suitable for communicating a signal to a surface active sensor probe, such as, for example, an on-chip device wherein the waveguide substrate is a semiconducting chip.

In addition, although only a single sensing element is shown on the fibers of the above-discussed examples, it should be understood that multiple sensing elements could be positioned on a single waveguide, or multiple waveguides having single or multiple sensors could be arranged to provide a multiplexing sensor array. In addition, each of the sensing elements could be designed to detect the same or different species to provide either enhanced detection, or multi-species detection simultaneously. An exemplary multiple sensor array is shown schematically in FIG. 1c. As shown, a system (30) of sensors (31) could be arrayed along a series of waveguides (32), which themselves are interconnected between one or more sources (33) and detectors (34).

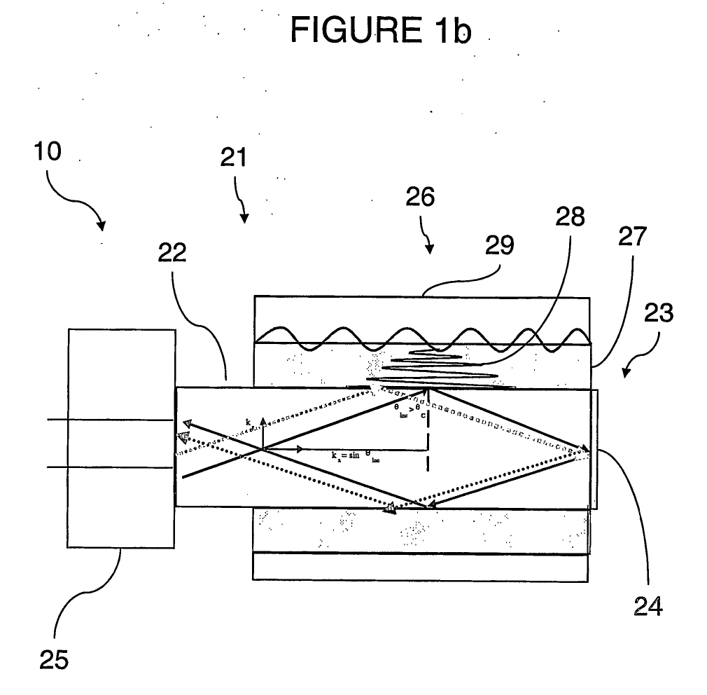

Regardless of the number or design of the surface active sensors in accordance with the current invention, during operation the surface active sensor of the current invention relies on a signal phenomenon that arises at the surface of a metallic film, and is highly sensitive to changes in the refractive index at the surface of a sensing element, such as for example, an electron charge density wave in an SPR sensor. A schematic of the exemplary SPR technique is shown in FIG. 2a. As shown, light (1) impinging on the sensor surface (2) undergoing total internal reflection exhibits an evanescent wave (3). This evanescent wave (3) can excite a standing charge (4) on a thin metallic film (5). In order for the standing charge (4) excitation on the metallic film (5) to occur, it must be in contact with a sample (6) of a lower refractive index than the waveguide (7). In order for this to occur, the wavevector of the standing charge kₛₚ, and the wavevector of the evanescent wave kₓ must be equal as described in Equations 1 and 2, below:

$$\begin{matrix}{k}_{sp} = {k}_{0} \sqrt{\frac{{ɛ}_{m} {ɛ}_{s}}{{ɛ}_{m} + {ɛ}_{s}}} & ( 1 ) \\ {k}_{x} = {k}_{0} {η}_{D} sin {Θ}_{inc} & ( 2 )\end{matrix}$$

where k₀ is the wavevector of the incident light, eₘ and eₛ are the complex dielectric constants of the metal and the sample respectively, h_{D} is the refractive index of the waveguide and Q_{inc} is the incident angle of the light. Multiple combinations of incident light angles and wavelengths can excite the standing charge. When this occurs, the photon is absorbed, shown by a minimum in the reflection spectra (see, for example, FIG. 2b). The position of the minimum (8_{SPR}) is indicative of the dielectric constant or the refractive index within 100-200 nm of the gold film. SPR is most sensitive for processes occurring at the surface, and the sensitivity of the technique decreases exponentially for processes occurring further from the surface.

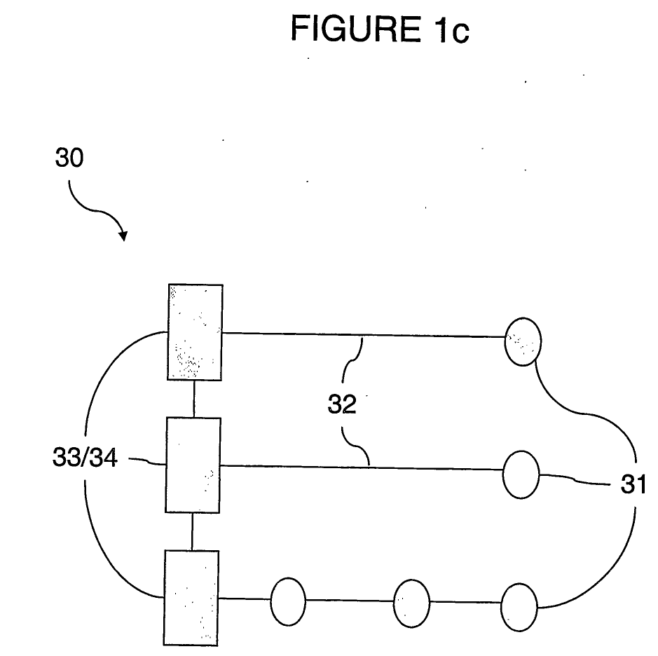

Regardless of the actual sensing technique used to probe the sensor element, all surface active sensors of the current invention utilize a surface initiated polymer or (SIP) sensor surface. A number of surface initiation techniques may be used in the method of the current invention. The application of a specific surface initiation technique depends only on the range of selectivity and sensitivity required for detecting a specific molecule. For example, in one embodiment, a free radical based initiator, such as 2,2′-Azobis(2-amidinopropane)dihydrochloride may be used. In such an embodiment the initiator is covalently linked to a self assembled monolayer of 11-Mercaptoundecanoic acid by a suitable coupling chemistry to initiate polymer growth on the surface of the fiber. In another exemplary embodiment, a long covalent chain, such as that shown in FIG. 3, may be immobilized on the surface of the fiber.

Likewise, regardless of the method of surface initiation, the surface initiated fiber may then processed in a mixture of monomers, imprint molecules and cross-linkers for polymer growth and molecular imprinting, or for covalently linking a probe molecule on the surface initiated polymer surface to provide target molecule specificity to the sensor.

In one embodiment target molecule specificity is provided by a process of molecular imprinting. Molecular imprinting in accordance with the current invention generally involves building a complex of a target molecule or ion with polymerizable ligands and copolymerizing the ligands with surface initiated polymers to immobilize the complex on the sensing surface, wherein after the extraction of the template molecules, complimentary cavities remain within the polymer, which will be available to detect any new template molecule or ion that interacts with the sensor.

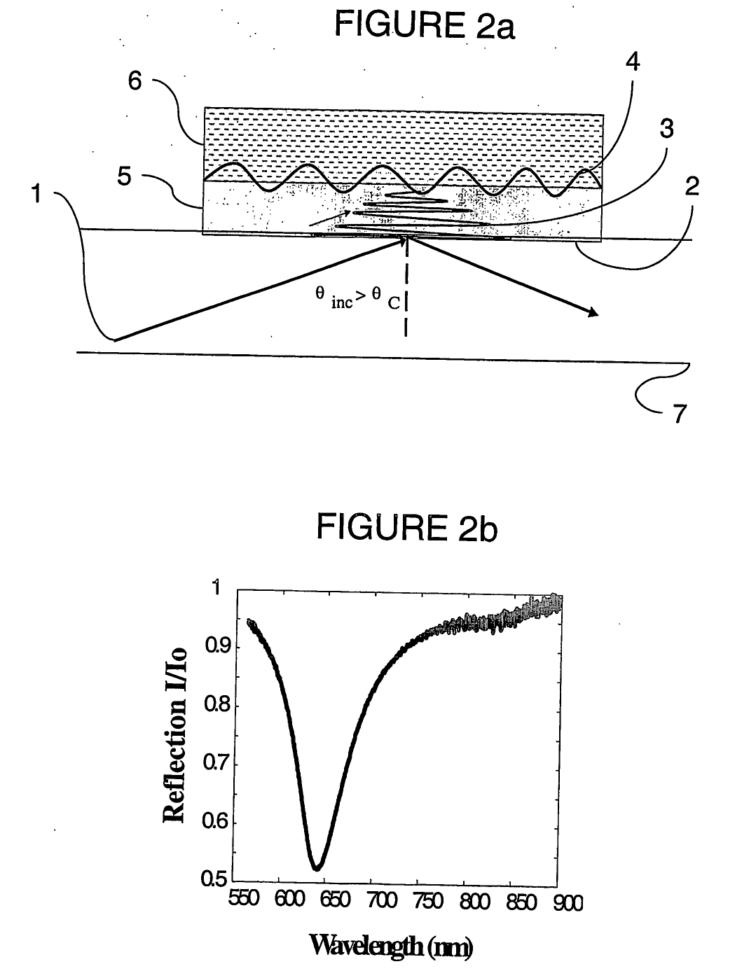

To this end, the current invention is also directed to methods of manufacturing surface active sensors using this molecular imprinting technique. In one embodiment, shown schematically in FIG. 4, the current invention is directed to the label free, surface initiated molecular imprinting technology for applications in surface active based molecular sensors, as described above. The process of molecular imprinting involves first growing a surface initiated polymer layer (40), as described above on the surface of the conductive layer (42) (Step 2), and then building a complex of a target molecule or ion (44) with polymerizable ligands (46) and copolymerizing the ligands with surface initiated polymers (40) to immobilize the complex on the sensing surface (Step 3). After the extraction of the template molecules (44), complimentary cavities (48) remain within the polymer (Step 4), which will be available to detect any new template molecule or ion.

Increased selectivity and sensitivity may be obtained by designing imprinted functional polymer matrices that are a few hundred nanometers thick, well within the effective distance of the penetration of surface plasmons and tailor made to detect specific chemical species of interest.

Although molecular imprinting techniques are described above, target molecule specificity can also be provided to the surface initiated polymer surface by covalently linking probe molecules on the surface. Exemplary embodiments of this technique have been previously described in “A Remote Implantable Sensor for Myocardial Infarction,” S Beaudoin, K. S. Booksh, P. K. Kairallah, A. Razatos, PCT Application No. PCT/US02/23300 or U.S. Provisional Patent Application No 60/303,956, the disclosures of which are incorporated herein by reference.

### EXAMPLES

The above general description of the surface active sensors in accordance with the current invention, and methods of manufacturing such sensors will be better understood with reference to the following non-limiting examples, which are directed to the detection of Pinacolyl Methyl Phosponate (PMP), a stimulant for the nerve agent Soman, toxic gases such as ammonia, and human antibodies such as myoglobin (MG) and cardiac Troponin I (cTnI).

Manufacture of the Fiber Sensor Element

The development of an exemplary fiber-optic based surface plasma resonance surface active sensor as shown in FIG. 1b has been well documented by Booksh et. al., “Sensitive and real-time fiber-optic-based surface plasmon resonance sensors for myoglobin and cardiac troponin I” J. F. Masson, L. A. Obando, S. Beaudoin, K. S. Booksh*, Talanta, 62, 865-870 (2004), the disclosure of which is incorporated herein by reference. In one exemplary embodiment, used in the examples described below, the fiber is a 400-micron silica core with a TECS cladding and a TEFZEL buffer (Thor Labs) with a numerical aperture of 0.39. The tip of the optical fiber is polished flat with lapping films (Thor Labs). A mirror is affixed onto the tip of the fiber optic probe by sputtering, first a layer of Cr (5 nm) followed by a layer of Au (50 nm). The fiber is then mounted in a SMA type connector polished to ensure good optical coupling with the fiber optic jumper. Finally, approximately 1 cm of cladding near the tip of the silica fiber is removed by rubbing the cladding with a wiper soaked in acetone and then Cr and Au are sputter coated in the sensing area. The fibers thus prepared may then be polymerized by surface initiation and molecular imprinting or covalent linking.

Surface Initiation of the Fiber Sensor Element

In one exemplary embodiment, a long covalent chain as shown in FIG. 3, is immobilized on the surface of the fiber. For example, by immersing a gold coated fiber overnight with 0.005M 11-mercaptoundecanol, and then washing, drying & reacting the fiber with epichlorhydrin in a mixture of diglyme and NaOH to give a reactive epoxide terminal. The epoxide can then be reacted with ethanolamine followed by reaction with 4,4′-Azobis(4-cyano-valeric acid) in the presence of an EDC/NHS mixture. All reactions may be monitored by ATR-FTIR to optimize reaction conditions, to ensure completion of the reactions, and to confirm the binding of the polymerization initiator to the surface of the sensor. The surface initiated fiber is then processed in a mixture of monomers, imprint molecules and cross-linkers for polymer growth and molecular imprinting, or for covalent linking of a probe molecule.

Molecularly Imprinted Polymers For PMP Detection

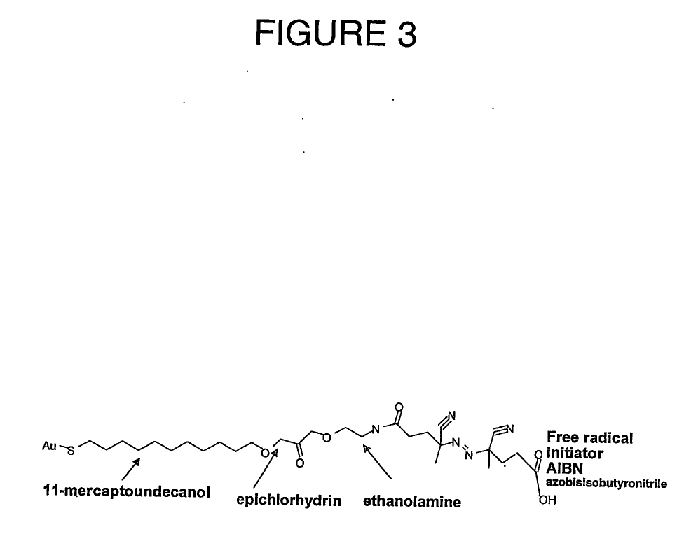

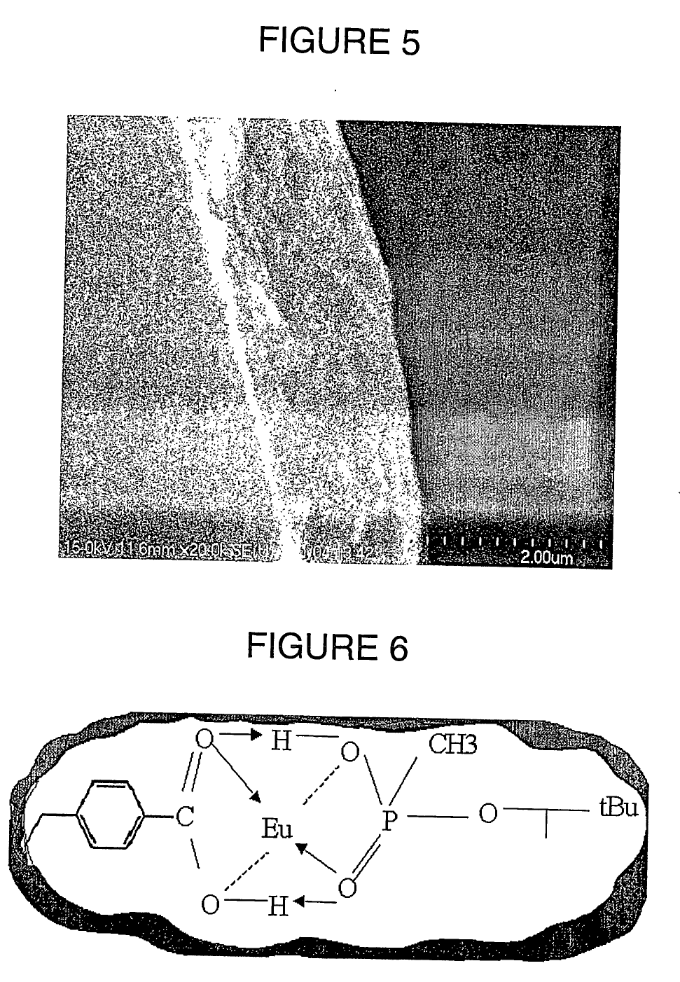

In developing a sensor for a PMP molecule specifically, the imprint molecule PMP, is present in a polymerizable complex as a Metal-Monomer-Template complex such as, [Europium(vinyl benzoate)ₙPMP], where the template molecule occupies a well-co-coordinated site within the complex. By copolymerizing the vinyl benzoate ligands present in the complex with a surface initiated polymer such as Styrene and a suitable level of cross-linker, the complex becomes bound in a polymeric network on the surface of the sensor as shown in FIGS. 5 & 6. After the extraction of the template molecules with suitable solvents, complimentary cavities will remain within the polymer, which will be available to detect any new PMP molecule in solution or in gaseous phase.

Detection of PMP Molecules by SPR

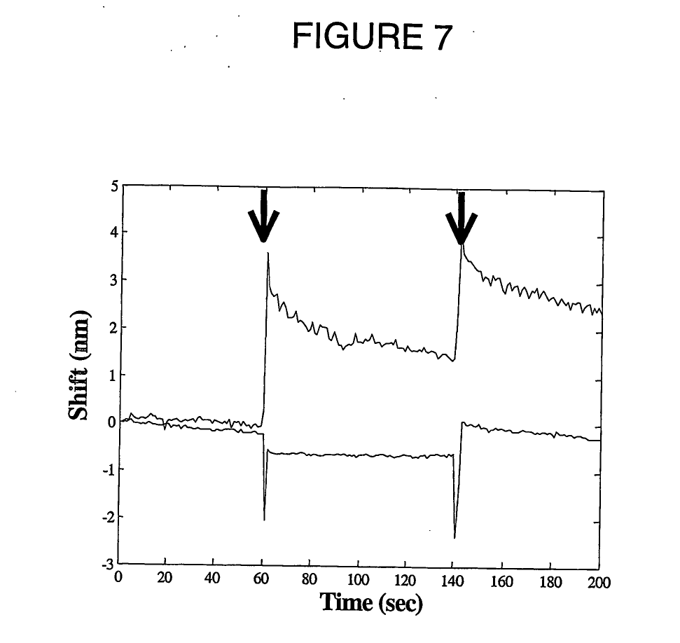

In order to investigate the use of MIP-based Surface Plasmon Resonance to detect PMP molecules, the binding phenomena were studied as shown in FIG. 7 using an SPR-based surface active sensor. Two different approaches, one based on polymerization from solution and the other from surface initiated polymerizations were studied. The graph shown in FIG. 7 has three regions: the first and third regions indicate the SPR responses of the solvent; and the second region indicates the SPR coupling wavelength changes in 100 ppb PMP sample. Surface Plasma Resonance signal measurements from the fiber were made by a JobinYvon SPEX 270M housing with an 1800 grooves/mm grating blazed at 450-850 nm (Jobin Yvon Inc). The arrows indicate the exchange point of the samples. A time-dependent, but large positive change in SPR coupling wavelength was observed from the surface initiated polymerization based PMP sensor. A wide range of chemically similar pesticides were tested and their interference studied. Complexes containing lanthanide elements were optimized to induce suitable luminescent signals with and without the imprint molecule for offline material optimization. As shown in FIG. 7, a minimum of at least a 15% increase in the signal sensitivity using surface initiated polymerization was observed.

Detection of Ammonia Using SPR

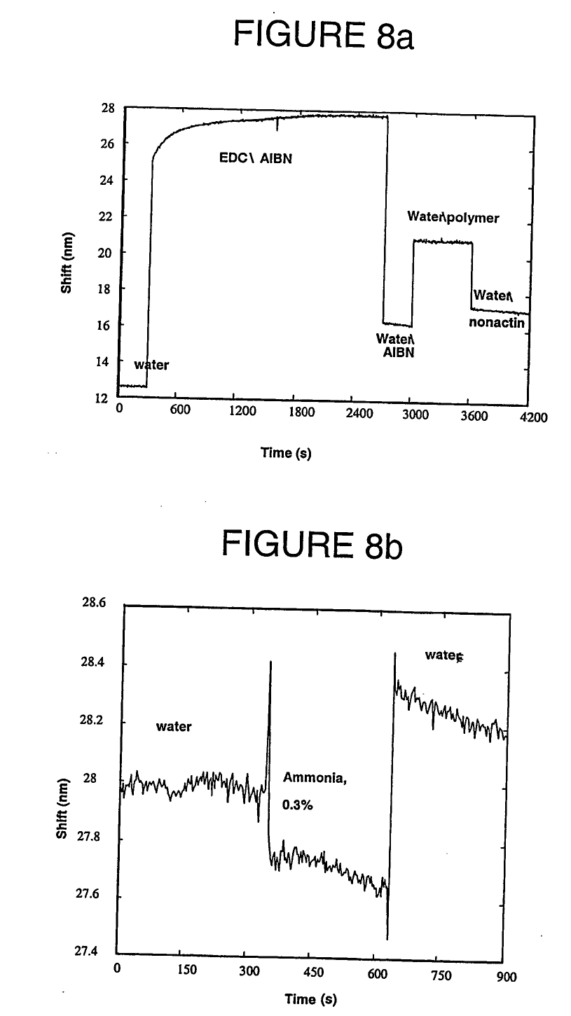

Several types of surface initiated matrix monomers, polymers and electrolytes were experimented with for the optical detection of ammonium ions and ammonia in the gas phase using an SPR-based surface active sensor. Using surface initiated techniques, highly reproducible polymer layers with high graft density can be formed and their formation monitored by SPR as shown in FIGS. 8a and 8b. Crown ethers such as Nonactin, an aminophore, were dip coated to enhance signal specificity due to ammonia absorption into its cavity. As shown in FIGS. 8a and 8b, the inclusion and exclusion of the target molecule into or out of the polymer layers creates a change in the refractive index of the polymeric material and is studied as shown below by the evanescent field created by the surface plasma resonance.

As described in the Examples and specification of the current invention, the surface initiated molecularly imprinted sensing elements of the current invention allow for the creation of tailor-made recognition elements (synthetic antibodies) that are capable of changing their optical characteristics in a predictable way in the presence of an imprint molecule, and are less prone to suffer from changes in pH, temperature, and trace of impurities that can easily contaminate conventional sensing surfaces.

### EXAMPLE

### Cardiac Muscle Death

Although the above embodiments have focused on environmental chemical sensors the sensors of the current invention can also be profitably used in the medical field. For example, cardiac disease is among the leading causes of death in the United States. Methods that would allow fast, definitive diagnosis of myocardial infarction (MI) or ischemia will significantly improve patient care. Currently, when patients go to the hospital after experiencing chest pain, tests are performed that involve electrical monitoring of heart rhythm, and the analysis of blood samples for markers of cardiac damage, creatinine kinase and cTnI. Depending on the hospital, it can take as few as 4 or more than 10 hours to obtain results from the blood analysis. If cardiac damage is found, anti-thrombolytic agents are administered to clear the heart blockage, or a catheterization is performed to open the blocked vessel. Unfortunately, many patients enter the hospital with unstable angina or other symptoms of ischemia or mild MI but do not present adequate markers to allow a definitive diagnosis. These patients commonly will have severe infarctions closely after the onset of the initial unstable angina. A way to monitor these patients for markers of MN more rapidly than the 4-10 hour lab timeframe, and a way to monitor continuously over a 12-24 hour period will significantly enhance patient care. Employing SPR-based surface active sensing on multimode optical fibers presents distinct advantages for in vivo analysis of pharmacological analytes, proteins, and other organic markers. Combining the sensitivity of SPR analysis with the selectivity of antibodies yields a powerful sensor system. SPR is a surface technique so the opacity of the blood matrix has minimal effect on the detection limits of the sensor. The response time is fast.

The sensors disclosed here could provide continuous monitoring for infarction markers over a clinically-relevant relevant time period. They also could be used by emergency response personnel in the field, who could transmit the output to the emergency room during patient transit. High-risk coronary artery disease patients also will benefit significantly from early detection and diagnosis of MI using these sensors.

In one exemplary embodiment, a sensor was formed to detect markers of cardiac muscle cell death at less than 3 ng/mL and in less than 10 minutes. Specifically, an SPR sensor in accordance with the current invention was designed to detect myoglobin (MG) and cardiac Troponin I (cTnI) in a HEPES buffered saline solution.

As discussed, MG and cTnI are two biological markers released from dying cardiac muscle cells during a myocardial infarction (MI), and their detection at biologically relevant levels can be diagnostic of MI. Myocardial infarctions are a leading cause of death. During a myocardial infarction, the cardiac muscles are damaged and some markers are released from these muscles. MG is the first marker released after damage to myocardial muscle cells. MG reaches a serum concentration of 15 to 30 ng/mL after an MI. Although its detection is not necessarily an indicator of MI, it gives a quick signal to indicate muscle damage. cTnI is released much more slowly than MG, but it has been recognized as a specific marker for myocardial damage. Thus, a rapid rise in serum MG followed by a heralding rise in cTnI has been shown to provide a definitive diagnosis of MI. Serum cTnI levels reach 1 to 3 ng/mL. A sequence of 31 residues at the N-terminus of cTnI is different from its skeletal counterpart, avoiding any false positives between cTnI and skeletal troponin I.

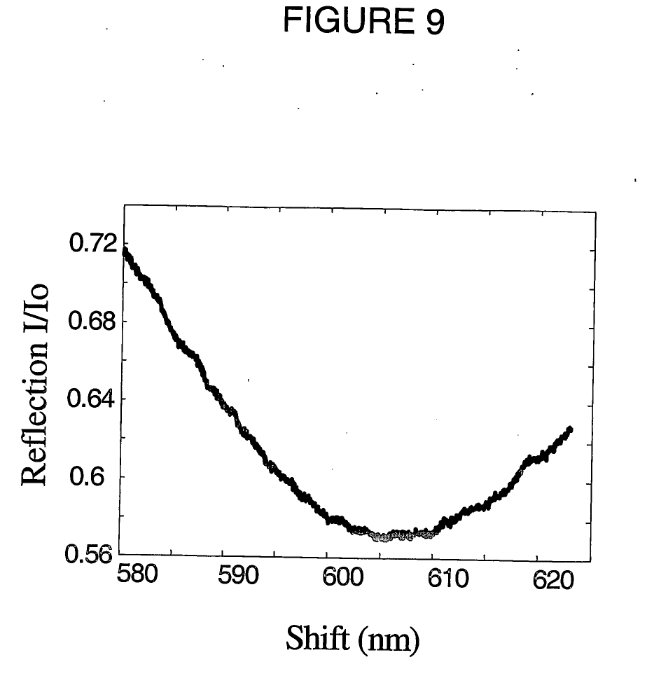

In the current example 400 micron diameter multimode fiber optics were employed for the sensor tip. However, multimode fibers as narrow as 50 microns could conceivably be used. In addition, the lengthening of the optical fiber at the tip could allow for the insertion of the probe into a vein for in vivo monitoring. In the current exemplary embodiment, two 200 micron diameter fibers are fitted into the custom design adaptor; one fiber brings light from the white LED employed as a source, the other returns the reflected light to the spectrometer and CCD detector. A Jobin-SPEX 270M spectrometer with a 1800 g/mm grating was used to narrow the spectral range to 42.8 nm. The spectra were collected with an Andor CCD camera. A resolution of 0.042 nm/pixel is therefore obtained. An example of a resonance curve obtained by the exemplary device is shown in FIG. 9. A second order polynomial is fitted to the SPR curve and the SPR minimum is found using the zero point of the first derivative for the second order polynomial.

To prepare the sensor generally, the gold coated surface of the SPR probe is treated with a thiol followed by reactions with epichlorhydrin and dextran. The resulting dextran surface is carboxymethylated and amine coupling to a solution of human anti-myoglobin is performed by using a suitable coupling chemistry (e.g. EDC/NHS). For cTnI detection, the dextran surface is carboxymethylated and amine coupling to a solution of human anti-cardiac Troponin I is performed by using a suitable coupling chemistry (e.g. EDC/NHS).

One exemplary SPR sensor was formed using a dextran layer, the synthesis of which is based on the carboxymethylated dextran chemistry used elsewhere for protein immobilization on a SPR surface[9]. All reactions occur in aqueous solution without any stirring or shaking. The bare gold surface on the SPR probe is contacted overnight with 0.005 M 11-mercaptoundecanol in an 80:20 solution of ethanol and water to form a self-assembled monolayer (SAM). This SAM is reacted with 0.6 M epichlorohydrin in a mixture of diglyme and 0.4 M NaOH for 4 hours. This layer is then washed with water, ethanol and water again. The surface is reacted for 20 hours with an aqueous solution containing 0.3 g/mL dextran and 0.1 M NaOH. The resulting dextran matrix is modified to a carboxymethylated matrix by reaction with 1M bromoacetic acid in 2 M NaOH for 16 hours. The surface is activated by immersion in 1:1 aqueous solutions of 0.4 M EDC (N-ethyl-N′-(3-dimethylaminopropyl)carbodiimide hydrochloride) and 0.01 M NHS (N-hydroxysuccinimide) for 10 minutes. An amine coupling is performed on this activated surface by reaction with a 700 mg/mL solution of human anti-myoglobin (ICN Biochemicals, polyclonal rabbit antiserum to human MG, K_{A} and k_{A} are not available) for 20 minutes. For cTnI detection, the surface is reacted with a 100 mg/mL human anti-cardiac Troponin I (Spectral Diagnostics, monoclonal mouse antiserum to human cTnI, clone 2I-14, K_{A}=2.69×10⁷M⁻¹ and k_{A}=6.51×10⁴M⁻¹s⁻¹) solution for 20 minutes. Next, the non-specifically bound proteins are washed away and the non-reacted sites on the dextran are deactivated by rinsing the probe with an aqueous solution of 1 M ethanolamine at pH 8.5, for 10 minutes. Finally, the probe is dipped in buffered aqueous solutions of MG or cTnI to test its performance. The sensor is equilibrated for 20 minutes in HBS pH 7.4. The data acquisition is started and the sensor is dipped in the antigen solution for 10 minutes. The sensor is regenerated in HBS for 5 minutes. The sensor is then ready for another measurement.

SPR sensors with the dextran attached to the surface were immersed in solutions of pH ranging from 2 to 12 to test their stability. Daily measurements of the SPR signal were taken for a 2 weeks period. Comparison with a reference bare gold probe did not show any degradation of the dextran layer.

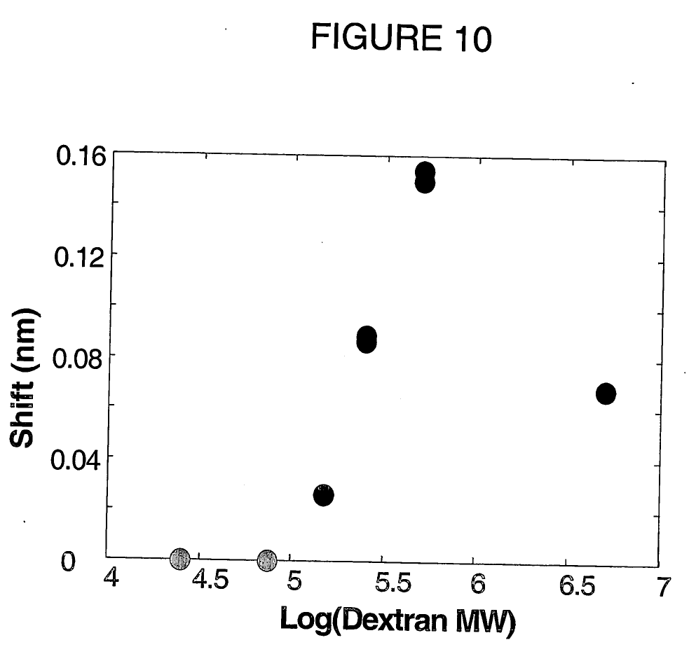

A blocked experimental design was developed to help determine the conditions that allow the maximum amount of antibodies to be bound to the dextran surface. The pH, the temperature and the dextran molecular weight were varied to evaluate their influence on the antibody loading. The antibody reaction efficiency with different dextran molecular weights was measured by tracking cTnI detection at 25 ng/mL in HEPES buffered saline (BBS) at pH 7.4. HBS provides a salt and pH environment similar to human blood. The sensors were prepared by immobilizing the antibody to the dextran at pH 6 in 10 mM CH₃COOH/CH₃COONa, at a reaction temperature of 37° C. The anti-cTnI to be bound to the dextran was prepared at 100 mg/mL. Dextran with average molecular weights of 25, 75, 150, 250, and 500 kDa and 5-40 MDa were used. cTnI sensitivity was found to be directly proportional to the dextran molecular weight until 500 kDa, as shown in FIG. 10.

In this figure, the logarithm of the molecular weight is plotted to better show the trend. As the dextran molecular weight increases, it offers more potential reaction sites for the anti-cTnI, allowing more anti-cTnI to react with the surface. Dextran with molecular weight between 5-40 MDa extends beyond the evanescent field on the gold SPR patch, therefore the amount of useful bound antigen binding is decreased compared to the 500 kDa circumstance. The dextran molecular weight for the experiments below was 500 kDa.

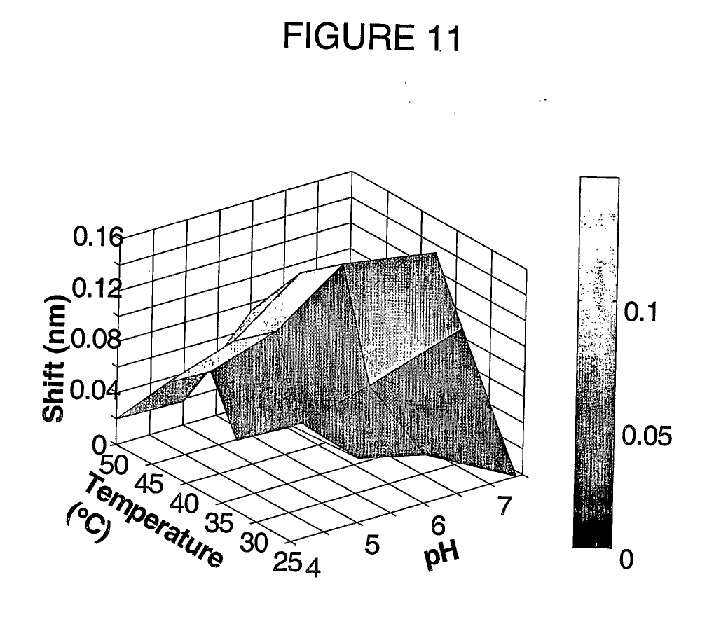

The pH and temperature were also simultaneously varied to map the efficiency of the antibody reaction as shown by the surface in FIG. 11. To measure the sensor's efficiency, it was dipped in a 25 ng/mL cTnI solution. The pH was varied from pH 4 to pH 7.4 and the temperature was varied from 25 to 50° C. The lower temperature did not degrade anti-cTnI at any pH, and as the pH is decreased into the acidic realm, the reaction becomes more efficient, as indicated by the larger shift in the wavelength of minimum returned light from the sensor compared to the signal from the antibody-coated dextran in the absence of antigen binding. The cause for this behavior can be attributed to several phenomena. The net result of these effects is that although the optimal condition for the anti-cTnI reaction with the carboxymethylated dextran is at 37° C. in a solution of pH 6, the probe can be used over a wide-range of temperatures and pHs. A similar evaluation of optimal binding conditions was performed for anti-MG reacting with the carboxymethylated dextran surface. The optimal condition for the anti-MG binding was found to be at 37° C. in a solution of pH 4.

The sensor's response to cTnI was evaluated in a HBS pH 7.4, and a calibration curve was developed. Anti-cTnI was immobilized at pH 6, in 10 mM CH₃COOH/CH₃COONa at a temperature of 37° C. However, cTnI detection was performed in a water bath at 25° C. cTnI concentrations ranging from 2.5 ng/mL to 100 ng/mL in HBS were tested. A sensor can be used for up to 4 measurements. No regeneration is required. When the sensor was put back in HBS for 5 minutes, the bounded antigen was removed. Replicates, with different sensors, were obtained at 10 and 25 ng/mL and showed less than 8% variation. The signal obtained using SPR has been shown to follow a Langmuir isotherm. In this case, the sensor output (the shift in the minimum in returned light from the sensor in nm) can be described using Equations 3 or 4.

$$\begin{matrix}\frac{Shift}{{Shift}_{max}} = \frac{KC}{1 + KC} & ( 3 ) \\ \frac{1}{Shift} = \frac{1}{{Shift}_{max} KC} + \frac{1}{{Shift}_{max}} & ( 4 )\end{matrix}$$

where Shift is the change in the minimum SPR wavelength (nm), Shiftₘₐₓ is the maximum change in the minimum SPR wavelength for a total antigen coverage on the sensor, C is the concentration of antigen in solution (mole/nm³) and K is the affinity constant for the antigen-antibody system.

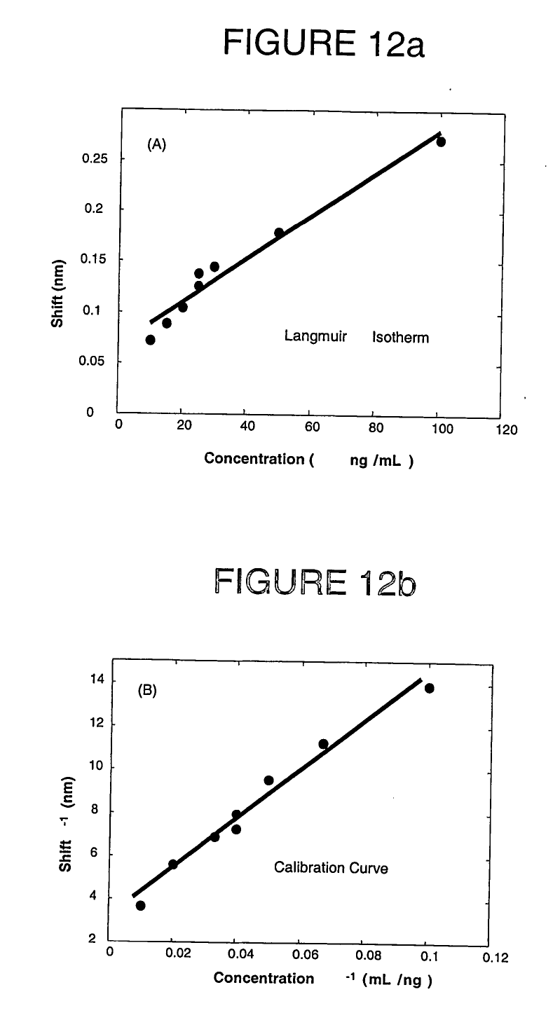

The advantage to Eq. 4 is that it predicts a linear relationship between shift⁻¹ and antigen concentration⁻¹. FIG. 12a shows the Langmnuir isotherm for cTnI binding. With the isotherm, the lower concentrations deviated more from linearity. FIG. 5b presents the cTnI binding results in the form of Eq. 4. As can be seen, the data points are scattered around the regression line, without showing any trends. The solid lines in the plots are the regression lines determined using a sum of least squares error analysis.

The limit of detection (LOD) is calculated from Equation 5, below.

$$LOD = \frac{3 n - b}{m} \qquad ( 5 )$$

where n is the noise in the signal, b is the y intercept of the Langmuir isotherm in the form of FIG. 12b and m is the slope of the regression line in FIG. 12b. The y intercept in the Langmuir isotherm is the maximum shift at saturation of the sensor. Thus, the LOD for cTnI is 1.4 ng/nL. A conservative estimate on the noise on the signal is 0.008 nm (5×10⁻⁶ RIU), thus the detection limit corresponds to a 1.5×10⁻⁵ RIU change. The noise is based on the error to fit a Langmuir isotherm to the binding kinetics of 25 ng/mL MG. This detection limit is within the 1-3 ng/mL detection range targeted for definitive diagnosis of myocardial infarction.

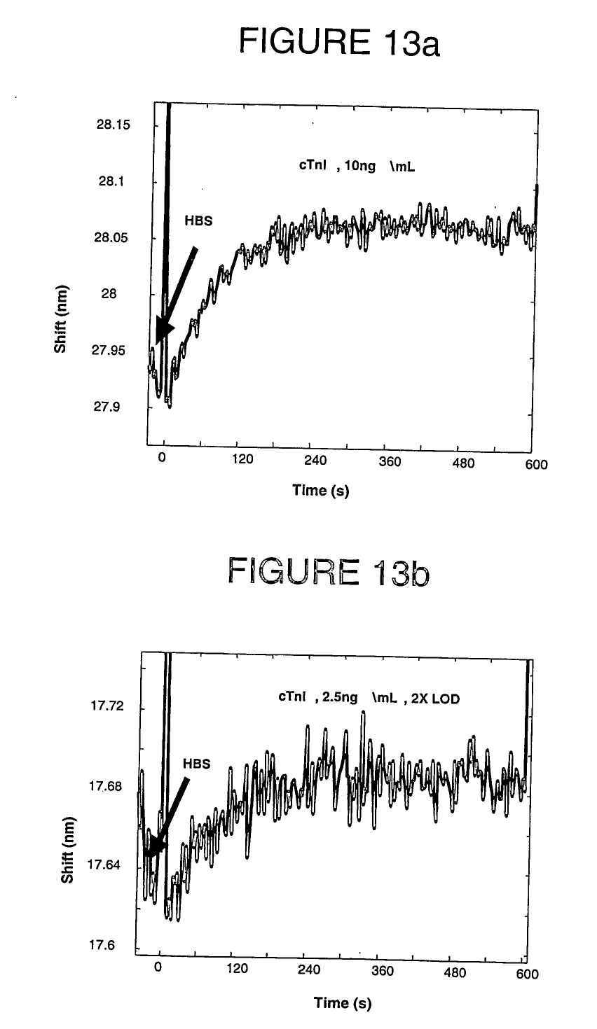

Although this limitation exist for the cTnI antibody, it should be understood that using an antibody with a larger affinity constant and further optimization of the sensor fabrication would improve the limit of detection. FIG. 13 shows that the sensor's response time is less than 10 minutes if the steady-state binding signal is used for both a large concentration 10 ng/mL and for a dilute solution at 2.5 ng/mL, twice the concentration of the LOD. If faster response times are required, the rate of change in the first 2 minutes, following Langmuir isotherm linearization, is also linear with respect to analyte concentration.

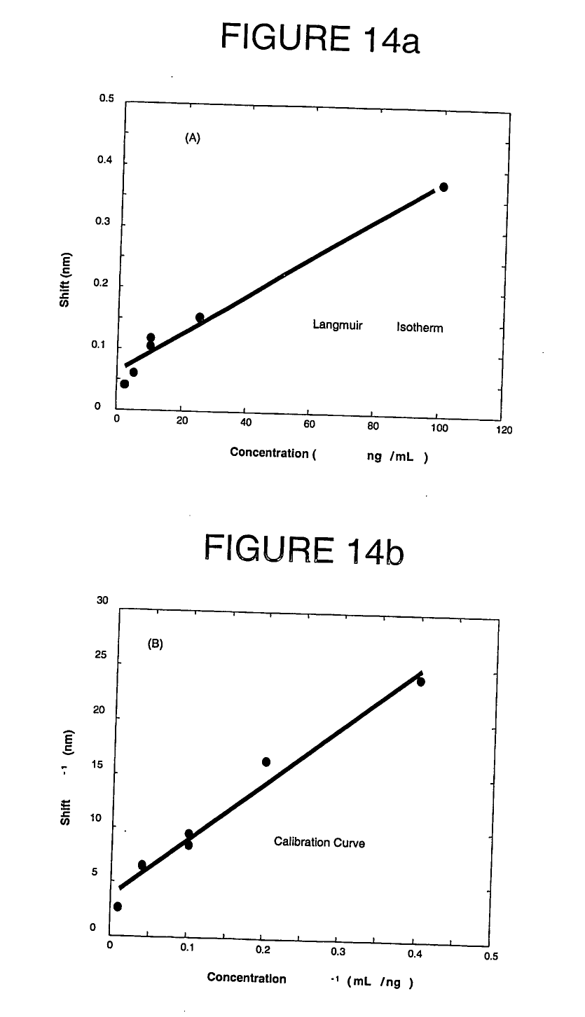

A calibration curve for MG was obtained for concentrations ranging from 10 to 100 ng/mL in the physiological buffer. The sensor was prepared by immobilizing anti-MG to the dextran at pH 4 and 37° C. Four measurements can be made with one sensor. The sensor does not need to be regenerated. Replicates at 25 ng/mL showed less than 7% variation in the SPR shift. Plotting the MG binding results according to Eqs 3 and 4, a Langmuir binding isotherm and calibration curve were confirmed for MG sensing. The binding data is plotted in the form of a Langmuir isotherm in FIG. 14a. The figure shows slight deviations from ideal behavior at the lower concentrations, while the calibration curve (binding data in the form of Eq. 4) shows only scatter around the regression line. The limit of detection for MG was calculated to be 2.9 ng/nL using Eq. 5. After myocardial muscle cell damage, serum MG levels reach 15 to 30 ng/mL. Therefore a limit of detection of 2.9 ng/mL is sufficiently low to detect damage to myocardial muscle cells. Table 1, below, summarizes the results for cTnI and MG.

TABLE 1
Sensor Performance in HBS at pH 7.4

| | cTnI | MG |
|---|---|---|
| LOD (ng/mL) | 1.4 | 2.9 |
| Linearity | Up to 100 ng/mL | Up to 100 ng/mL |
| Replicate | 8% variation | 7% variation |
| Selectivity RMSE (ng/mL) | 6.7 | 3.3 |

In summary, a sensor to detect biologically relevant concentrations of MG and cTnI in significantly less than 10 minutes has been demonstrated. The amount of antibody bound to the sensor surface was maximized by modifying the pH and temperature of the binding reaction of the antibody to the carboxymethylated dextran. Maximum antibody loading was obtained at pH 6 and a reaction temperature of 37° C. for anti-cTnI. The maximum amount of anti-MG on the probe was obtained at pH 4 and a reaction temperature of 37° C. The dextran molecular weight influences also the antibody loading on the surface. Larger dextran increases the antibody loading up to 500 kDa, but decreases when 5-40 MDa was attached to the probe. The limits of detection were of 1.4 ng/mL and 2.9 ng/mL for cTnI and myoglobin. The dextran polymer used for the antibody attachment to the probe surface was stable for at least two weeks of continuous exposure to aqueous solutions of pH 2 to 12.

While several forms of the present invention have been illustrated and described, it will be apparent to those of ordinary skill in the art that various modifications and improvements can be made without departing from the spirit and scope of the invention. Accordingly, it is not intended that the invention be limited, except as by the appended claims.

Specifically, although specific exemplary sensors for the detection of PMP, ammonia, biomarkers cardiac troponin I (cTnI) and myoglobin. have been disclosed herein, it should be understood that using the concepts disclosed herein surface plasmon resonance based highly sensitive sensors may be designed by growing nano-layers of molecularly imprinted polymers, or polymer matrix by surface initiated polymerization techniques, and that these sensors may be tailor made to sense a broad spectrum of chemicals in a variety of chemical environments both environmental and biological in real time.

What is claimed is:

1. A surface active sensor comprising:
a waveguide defining a signal path in signal communication with a signal source and a signal detector;
a sensing element disposed in the signal path between said signal source and said signal detector comprising a conductive layer disposed on the surface of said waveguide, and a surface initiated polymer sensing layer having at least one binding site specifically designed to bind a target molecule, said sensing layer being disposed on the surface of said conductive layer; and
wherein said sensing layer is in signal communication with said waveguide such that binding of a target molecule on the sensing layer causes a detectable perturbation in a signal transmitted along said waveguide.

2. The surface active sensor of claim 1, wherein the waveguide is a fiber optic.

3. The surface active sensor of claim 1, wherein the detector is a photomultiplier tube.

4. The surface active sensor of claim 1, wherein the source is a light source.

5. The surface active sensor of claim 1, wherein the conductive layer is gold.

6. The surface active sensor of claim 1, wherein the sensor utilizes a technique selected from the group consisting of surface plasmon resonance, surface acoustic wave, piezoelectric or quartz crystal microbalance, micro cantilever; or field effect transistor to monitor the sensing layer.

7. The surface active sensor of claim 1, wherein the sensing layer is in evanescent communication with the waveguide.

8. The surface active sensor of claim 1, wherein said surface initiated polymer sensing layer is a dextran layer.

9. The surface active sensor of claim 1, wherein the selectivity and sensitivity of the surface initiated polymer sensing layer towards the target molecule is tailored by optimizing a polymeric property selected from the group consisting of chain length, polymer thickness, and type of polymer matrix.

10. The surface active sensor of claim 1, wherein the binding site is formed in the sensing layer by one of either molecular imprinting of an imprint molecule in the sensing layer, or covalent linking a target specific probe to the sensing layer.

11. The surface active sensor of claim 1, wherein the sensing layer comprises a nano-layer containing at least one a cavity.

12. The surface active sensor of claim 11, wherein the at least one cavity is lined with at least one complexing ligand selected to selectively bind a target molecule based on at least one property of the target molecule.

13. The surface active sensor of claim 12, wherein the at least one property of the target molecule is selected from the group consisting of charge, co-ordination number, coordination geometry and size.

14. The surface active sensor of claim 1, further comprising a signal reflector disposed distal to the sensing element, and wherein the waveguide comprises a source signal path disposed between the signal source and the reflector and a detector signal path disposed between the reflector and the signal detector such that after interaction with the sensing element the signal is reflected by the reflector along the detector signal path to the detector.

15. The surface active sensor of claim 1, wherein the target molecule is one of either a molecule or an ion.

16. The surface active sensor of claim 1, wherein the sensor operates in at least one of a gaseous and liquid phase.

17. A surface active sensor comprising:
a waveguide having proximal and distal ends, wherein said proximal end is in signal communication with a signal source and a signal detector;
a signal reflector disposed on said distal end of said waveguide for reflecting said signal from said signal source back along said waveguide to said signal detector; and
a sensing element between said proximal end and said reflector comprising a conductive layer disposed on the surface of said waveguide, and a surface initiated polymer sensing layer disposed on the surface of said conductive layer, wherein said sensing layer is in signal communication with said waveguide such that binding of a target molecule to the sensing layer causes a detectable perturbation in a signal transmitted along said waveguide, and wherein said sensing layer is modified to specifically detect the target molecule.

18. The surface active sensor of claim 17, wherein the waveguide is a fiber optic.

19. The surface active sensor of claim 17, wherein the detector is a photomultiplier tube.

20. The surface active sensor of claim 17, wherein the source is a light source.

21. The surface active sensor of claim 17, wherein the conductive layer is gold.

22. The surface active sensor of claim 17, wherein the sensor utilizes a technique selected from the group consisting of surface plasmon resonance, surface acoustic wave, piezoelectric or quartz crystal microbalance, micro cantilever, or field effect transistor to monitor the sensing layer.

23. The surface active sensor of claim 17, wherein the sensing layer is in evanescent communication with the waveguide.

24. The surface active sensor of claim 17, wherein said surface initiated polymer sensing layer is a dextran layer.

25. The surface active sensor of claim 17, wherein the selectivity and sensitivity of the surface initiated polymer sensing layer towards the target molecule is tailored by optimizing a polymeric property selected from the group consisting of chain length, polymer thickness, and type of polymer matrix.

26. The surface active sensor of claim 17, wherein the binding site is formed in the sensing layer by one of either molecular imprinting of an imprint molecule in the sensing layer, or covalent linking a target specific probe to the sensing layer.

27. The surface active sensor of claim 17, wherein the sensing layer comprises a nano-layer containing at least one a cavity.

28. The surface active sensor of claim 27, wherein the at least one cavity is lined with at least one complexing ligand selected to selectively bind a target molecule based on at least one property of the target molecule.

29. The surface active sensor of claim 28, wherein the at least one property of the target molecule is selected from the group consisting of charge, co-ordination number, coordination geometry and size.

30. A method of forming a surface active sensor comprising:
providing a sensor probe comprising a waveguide defining a signal path in signal communication with a signal source and a signal detector, and a sensing element disposed in the signal path between said signal source and said signal detector comprising a conductive layer disposed on the surface of said waveguide;
covalently linking a polymerization initiator to the conductive layer of the sensing element;
providing a complex of an imprint molecule and a polymerizable ligand;
copolymerizing the complex with the surface initiated polymers to form a surface polymer layer; and extracting the imprint molecules to form cavities in the surface polymer layer complementary to a target species.

31. The method of claim 30, wherein the surface polymer layer is few hundred nanometers thick.

32. A method of forming a surface active sensor comprising:
providing a sensor probe comprising a waveguide defining a signal path in signal communication with a signal source and a signal detector, and a sensing element disposed in the signal path between said signal source and said signal detector comprising a conductive layer disposed on the surface of said waveguide;
covalently linking a polymerization initiator to the conductive layer of the sensing element;
providing a complex of a probe molecule and a polymerizable ligand;
copolymerizing the complex with the surface initiated polymers to form a surface polymer layer having a plurality of probe molecules covalently linked thereto, wherein the probe molecules selectively interact with a target species.
